(19) United States
(12) Patent Application Publication
(10) Pub. No.: US 2009/0093893 A1
(43) Pub. Date: Apr. 9, 2009

(54) System and method for recognizing and compensating for invalid regression model applied to abnormal situation prevention

(75) Inventor: John P. Miller, Eden Prairie, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER-ROSEMOUNT SYSTEMS, INC., Austin, TX (US)

(21) Appl. No.: 11/973,024

(22) Filed: Oct. 5, 2007

(51) Int. Cl. G05B 13/04

(52) U.S. Cl. 700/30

(57) ABSTRACT

A system for preventing abnormal situations in process plants is provided. A polynomial regression model is employed to predict values of a monitored variable based on measured samples of a load variable. An abnormal situation is detected when a predicted value of the monitored variable differs from a measured value of the monitored variable by more than a predetermined. The system recognizes when a data model is invalid and takes steps to compensate for the invalid model.

### FIELD OF THE DISCLOSURE

The present disclosure relates generally to abnormal situation prevention in a process plant. More particularly, the disclosure relates to recognizing an invalid regression model created for detecting an abnormal situation in a process plant and taking steps to achieve a valid regression model.

### BACKGROUND

Process control systems, like those used in chemical, petroleum or other processes, typically include one or more centralized or decentralized process controllers communicatively coupled to at least one host or operator workstation and to one or more process control and instrumentation devices such as, for example, field devices, via analog, digital or combined analog/digital buses. Field devices, which may be, for example, valves, valve positioners, switches, transmitters, and sensors (e.g., temperature, pressure, and flow rate sensors), are located within the process plant environment, and perform functions within the process such as opening or closing valves, measuring process parameters, increasing or decreasing fluid flow, etc. Smart field devices such as field devices conforming to the well-known FOUNDATION™ Fieldbus (hereinafter “fieldbus”) protocol or the HART® protocol may also perform control calculations, alarming functions, and other control functions commonly implemented within the process controller.

The process controllers, which are typically located within the process plant environment, receive signals indicative of process measurements or process variables made by or associated with the field devices and/or other information pertaining to the field devices, and execute controller applications. The controller applications implement, for example, different control modules that make process control decisions, generate control signals based on the received information, and coordinate with the control modules or blocks being performed in the field devices such as HART® and fieldbus field devices. The control modules in the process controllers send the control signals over the communication lines or signal paths to the field devices, to thereby control the operation of the process.

Information from the field devices and the process controllers is typically made available to one or more other hardware devices such as, for example, operator workstations, maintenance workstations, personal computers, handheld devices, data historians, report generators, centralized databases, etc. to enable an operator or a maintenance person to perform desired functions with respect to the process such as, for example, changing settings of the process control routine, modifying the operation of the control modules within the process controllers or the smart field devices, viewing the current state of the process or of particular devices within the process plant, viewing alarms generated by field devices and process controllers, simulating the operation of the process for the purpose of training personnel or testing the process control software, diagnosing problems or hardware failures within the process plant, etc.

While a typical process plant has many process control and instrumentation devices such as valves, transmitters, sensors, etc. connected to one or more process controllers, there are many other supporting devices that are also necessary for or related to process operation. These additional devices include, for example, power supply equipment, power generation and distribution equipment, rotating equipment such as turbines, motors, etc., which are located at numerous places in a typical plant. While this additional equipment does not necessarily create or use process variables and, in many instances, is not controlled or even coupled to a process controller for the purpose of affecting the process operation, this equipment is nevertheless important to, and ultimately necessary for proper operation of the process.

As is known, problems frequently arise within a process plant environment, especially a process plant having a large number of field devices and supporting equipment. These problems may take the form of broken, malfunctioning or underperforming devices, plugged fluid lines or pipes, logic elements, such as software routines, being improperly configured or being in improper modes, process control loops being improperly tuned, one or more failures in communications between devices within the process plant, etc. These and other problems, while numerous in nature, generally result in the process operating in an abnormal state (i.e., the process plant being in an abnormal situation) which is usually associated with suboptimal performance of the process plant. Many diagnostic tools and applications have been developed to detect and determine the cause of problems within a process plant and to assist an operator or a maintenance person to diagnose and correct the problems once the problems have occurred and been detected. For example, operator workstations, which are typically connected to the process controllers through communication connections such as a direct or a wireless bus, an Ethernet, a modem, a phone line, and the like, have processors and memories that are adapted to run software or firmware, such as the DeltaV™ and Ovation™ control systems, sold by Emerson Process Management, wherein the software includes numerous control module and control loop diagnostic tools. Likewise, maintenance workstations, which may be connected to the process control devices, such as field devices, via the same communication connections as the controller applications, or via different communication connections, such as OPC connections, handheld connections, etc., typically include one or more applications designed to view maintenance alarms and alerts generated by field devices within the process plant, to test devices within the process plant and to perform maintenance activities on the field devices and other devices within the process plant. Similar diagnostic applications have been developed to diagnose problems within the supporting equipment within the process plant.

Thus, for example, the AMS™ Suite: Intelligent Device Manager application (at least partially disclosed in U.S. Pat. No. 5,960,214 entitled “Integrated Communication Network for use in a Field Device Management System”) sold by Emerson Process Management, enables communication with and stores data pertaining to field devices to ascertain and track the operating state of the field devices. In some instances, the AMS™ application may be used to communicate with a field device to change parameters within the field device, to cause the field device to run applications on itself such as, for example, self-calibration routines or self-diagnostic routines, to obtain information about the status or health of the field device, etc. This information may include, for example, status information (e.g., whether an alarm or other similar event has occurred), device configuration information (e.g., the manner in which the field device is currently or may be configured and the type of measuring units used by the field device), device parameters (e.g., the field device range values and other parameters), etc. Of course, this information may be used by a maintenance person to monitor, maintain, and/or diagnose problems with field devices.

Similarly, many process plants include equipment monitoring and diagnostic applications such as, for example, Machinery Health™ applications provided by CSI, or any other known applications used to monitor, diagnose, and optimize the operating state of various rotating equipment. Maintenance personnel usually use these applications to maintain and oversee the performance of rotating equipment in the plant, to determine problems with the rotating equipment, and to determine when and if the rotating equipment must be repaired or replaced. Similarly, many process plants include power control and diagnostic applications such as those provided by, for example, the Liebert and ASCO companies, to control and maintain the power generation and distribution equipment. It is also known to run control optimization applications such as, for example, real-time optimizers (RTO+), within a process plant to optimize the control activities of the process plant. Such optimization applications typically use complex algorithms and/or models of the process plant to predict how inputs may be changed to optimize operation of the process plant with respect to some desired optimization variable such as, for example, profit.

These and other diagnostic and optimization applications are typically implemented on a system-wide basis in one or more of the operator or maintenance workstations, and may provide preconfigured displays to the operator or maintenance personnel regarding the operating state of the process plant, or the devices and equipment within the process plant. Typical displays include alarming displays that receive alarms generated by the process controllers or other devices within the process plant, control displays indicating the operating state of the process controllers and other devices within the process plant, maintenance displays indicating the operating state of the devices within the process plant, etc. Likewise, these and other diagnostic applications may enable an operator or a maintenance person to retune a control loop or to reset other control parameters, to run a test on one or more field devices to determine the current status of those field devices, to calibrate field devices or other equipment, or to perform other problem detection and correction activities on devices and equipment within the process plant.

While these various applications and tools are very helpful in identifying and correcting problems within a process plant, these diagnostic applications are generally configured to be used only after a problem has already occurred within a process plant and, therefore, after an abnormal situation already exists within the plant. Unfortunately, an abnormal situation may exist for some time before it is detected, identified and corrected using these tools, resulting in the suboptimal performance of the process plant for the period of time before which the problem is detected, identified and corrected. In many cases, a control operator will first detect that some problem exists based on alarms, alerts or poor performance of the process plant. The operator will then notify the maintenance personnel of the potential problem. The maintenance personnel may or may not detect an actual problem and may need further prompting before actually running tests or other diagnostic applications, or performing other activities needed to identify the actual problem. Once the problem is identified, the maintenance personnel may need to order parts and schedule a maintenance procedure, all of which may result in a significant period of time between the occurrence of a problem and the correction of that problem, during which time the process plant runs in an abnormal situation generally associated with the sub-optimal operation of the plant.

Additionally, many process plants can experience an abnormal situation which results in significant costs or damage within the plant in a relatively short amount of time. For example, some abnormal situations can cause significant damage to equipment, the loss of raw materials, or significant unexpected downtime within the process plant if these abnormal situations exist for even a short amount of time. Thus, merely detecting a problem within the plant after the problem has occurred, no matter how quickly the problem is corrected, may still result in significant loss or damage within the process plant. As a result, it is desirable to try to prevent abnormal situations from arising in the first place, instead of simply trying to react to and correct problems within the process plant after an abnormal situation arises.

One technique collects data that enables a user to predict the occurrence of certain abnormal situations within a process plant before these abnormal situations actually arise or shortly after they arise, with the purpose of taking steps to prevent the predicted abnormal situation or to correct the abnormal situation before any significant loss within the process plant takes place. This procedure is disclosed in U.S. patent application Ser. No. 09/972,078, now U.S. Pat. No. 7,085,610, entitled “Root Cause Diagnostics” (based in part on U.S. patent application Ser. No. 08/623,569, now U.S. Pat. No. 6,017,143). The entire disclosures of both of these applications/patents are incorporated herein by reference. Generally speaking, this technique places statistical data collection and processing blocks or statistical processing monitoring (SPM) blocks, in each of a number of devices, such as field devices, within a process plant. The statistical data collection and processing blocks collect, for example, process variable data and determine certain statistical measures associated with the collected data, such as a mean, a median, a standard deviation, etc. These statistical measures may then be sent to a user interface or other processing device and analyzed to recognize patterns suggesting the actual or future occurrence of a known abnormal situation. Once a particular suspected abnormal situation is detected, steps may be taken to correct the underlying problem, thereby avoiding the abnormal situation in the first place.

Many abnormal situation prevention algorithms rely on some type of regression to model a certain monitored variable as a function of some other load variable. The regression model may be calculated during a training phase in which a set of training data comprising a number of corresponding samples of the load variable and the monitored variable are analyzed to derive a function or curve that best fits the data in the training set. Once the regression model has been calculated the model may be used to predict values of the monitored variable based on measured values of the load variable received during a monitoring phase. The predicted values of the monitored variable may be compared to corresponding measured values of the monitored variable. An abnormal situation may be detected when a predicted value of the monitored variable differs from a corresponding measured value of the monitored variable by more than a predetermined amount.

The regression model may be a polynomial function of a particular order p. For example, the regression model may be a linear function (1^{st} order), a quadratic function (2^{nd} order), a cubic function (3^{rd} order), and so forth. In general, a higher order polynomial will more closely fit the data in the training set. It is possible, however, that a polynomial regression model may “over-fit” the data in the training set. In this case, the polynomial order is too high, and although the model will very accurately describe the data in the training set, it will not be particularly useful for predicting future values of the monitored variable based on values of the load variable received during the monitoring phase. What is more, some processing platforms may be subject to rounding off errors. If a higher order polynomial regression model is used there is a greater chance that the regression matrix will be ill-conditioned due to rounding off errors. In this case, when the polynomial regression coefficients are calculated they may describe a curve that does not even remotely resemble the data in the training set. In such cases it may be desirable to reduce the order of the polynomial and calculate a new regression model. In order to do so, however, it is first necessary to determine when a polynomial regression model is invalid. Only then may steps be taken to correct the problem and generate a valid model.

### SUMMARY OF THE DISCLOSURE

The present disclosure relates to abnormal situation prevention in a process plant. Polynomial regression models are generated to model various monitored process variables as a function of one or more load variables. The models may be used to predict values of a monitored variable based on measured values of a corresponding load variable. An abnormal situation may be detected if a measured value of the monitored variable differs from a corresponding predicted value of the monitored variable by more than a predetermined amount. The regression model is calculated based on a set of training data comprising a plurality of data samples including measured values of the monitored variable and the load variable. The regression model may comprise a polynomial function of a particular order. For example, the regression curve may be linear function (1^{st} order), a quadratic function (2^{nd} order), a cubic function (3^{rd} order), and so forth. The present disclosure relates to systems and methods for automatically determining whether a calculated regression model is valid. If a regression model is found to be invalid, measures may be taken to compensate for the rounding off errors or other factors that led to the invalid regression model. Once such steps have been taken, a new polynomial regression model may be calculated.

According to an embodiment, an abnormal prevention system includes at least one field device. The at least one field device is adapted to measure process control data associated with first and second process control variables. The embodiment further includes one or more processors. The one or more processors are adapted to generate a polynomial regression model for modeling the second process control variable as a function of the first process control variable. The polynomial regression model is calculated based on a plurality of sample values of the first and second variables included in a set of training data set. The one or more processors are further adapted to execute an algorithm for determining whether the calculated polynomial regression model is valid.

The algorithm for determining whether the polynomial regression model is valid includes calculating the average value of the polynomial regression model over the range of values of the first process control variable included in the training data set. The algorithm further identifies the minimum and maximum values of the second process control variable contained in the data set. The average value of the polynomial regression model is compared to the minimum and maximum values of the second process control variable to determine whether the average value of the polynomial regression model falls within the range of values between the minimum and maximum values of the second process control variable. If so, the model is valid. If not, the model is invalid. If the model is invalid the order of the polynomial regression model may be reduced by one and a new polynomial regression model calculated from the training data set. This process may be repeated until a valid model achieved.

Another embodiment describes a method of creating a polynomial regression model modeling process control data. The method calls for receiving a set of training data. Again, the training data include a plurality of first process control variable values and a plurality of corresponding second process variable values. The method further calls for calculating a polynomial regression model based on the values of the first and second process control variables included in the set of training data. The calculated polynomial regression model has an initial polynomial order. Next the method calls for determining whether the polynomial regression model is valid. This step may involve identifying the minimum and maximum values of the second process control variable included in the set of training data. The average value of the polynomial regression model is calculated over the range of first process control variable values included in the set of training data. The average value of the polynomial regression model is then compared to the minimum and maximum values of the second process control variable to determine whether the average value of the polynomial regression model falls within the range of values defined by the minimum and maximum values of the second process control variable. If the average value of the polynomial regression model is outside the range of values of the second process control variable, the model is invalid. When it is determined that a polynomial regression model is invalid, the order of the polynomial may be reduced by 1 and a new regression model may be calculated. The steps of calculating a polynomial regression model, determining whether the polynomial regression model is valid, reducing the polynomial order if the polynomial regression model is invalid, and calculating a new regression model may be repeated until a valid polynomial regression model is achieved.

Further aspects and advantages will be apparent to those of ordinary skill in the art from a review of the following detailed description, taken in conjunction with the drawings. While the compositions and methods are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

FIG. 1 is an exemplary block diagram of a process plant having a distributed control and maintenance network including one or more operator and maintenance workstations, controllers, field devices and supporting equipment.

FIG. 2 is an exemplary block diagram of a portion of the process plant of FIG. 1 illustrating communication interconnections between various components of an abnormal situation prevention system located within different elements of the process plant.

FIG. 3 is an example of an abnormal situation prevention system utilizing one or more regression models.

FIG. 4 is an example of a sixth order polynomial fitted to a set of training data that is invalid due to round off errors in the calculation of the polynomial coefficients.

FIG. 5 is an example of a valid first order regression model fitted to a set of training data.

FIG. 6 is a flow chart illustrating a method of creating a polynomial regression model of process control data.

### DETAILED DESCRIPTION

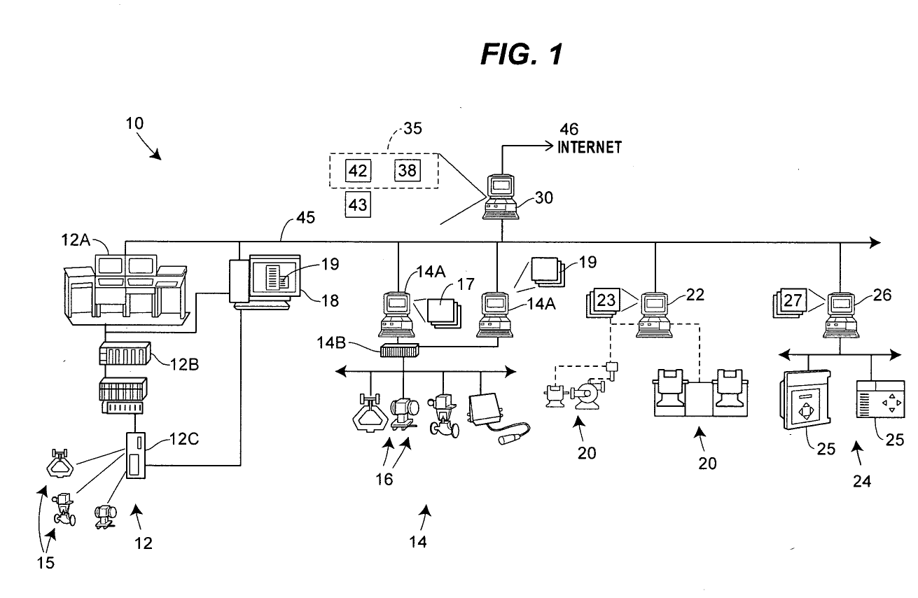

Referring now to FIG. 1, an example process plant 10 in which an abnormal situation prevention system may be implemented includes a number of control and maintenance systems interconnected together with supporting equipment via one or more communication networks. In particular, the process plant 10 of FIG. 1 includes one or more process control systems 12 and 14. The process control system 12 may be a traditional process control system such as a PROVOX or RS3 system or any other control system which includes an operator interface 12A coupled to a controller 12B and to input/output (I/O) cards 12C which, in turn, are coupled to various field devices such as analog and Highway Addressable Remote Transmitter (HART) field devices 15. The process control system 14, which may be a distributed process control system, includes one or more operator interfaces 14A coupled to one or more distributed controllers 14B via a bus, such as an Ethernet bus. The controllers 14B may be, for example, DeltaV™ controllers sold by Emerson Process Management of Austin, Tex. or any other desired type of controllers. The controllers 14B are connected via I/O devices to one or more field devices 16, such as for example, HART or Fieldbus field devices or any other smart or non-smart field devices including, for example, those that use any of the PROFIBUS®, WORLDFIP®, Device-Net®, AS-Interface and CAN protocols. As is known, the field devices 16 may provide analog or digital information to the controllers 14B related to process variables as well as to other device information. The operator interfaces 14A may store and execute tools available to the process control operator for controlling the operation of the process including, for example, control optimizers, diagnostic experts, neural networks, tuners, etc.

Still further, maintenance systems, such as computers executing the AMS application or any other device monitoring and communication applications may be connected to the process control systems 12 and 14 or to the individual devices therein to perform maintenance and monitoring activities. For example, a maintenance computer 18 may be connected to the controller 12B and/or to the devices 15 via any desired communication lines or networks (including wireless or handheld device networks) to communicate with and, in some instances, reconfigure or perform other maintenance activities on the devices 15. Similarly, maintenance applications such as the AMS application may be installed in and executed by one or more of the user interfaces 14A associated with the distributed process control system 14 to perform maintenance and monitoring functions, including data collection related to the operating status of the devices 16.

The process plant 10 also includes various rotating equipment 20, such as turbines, motors, etc. which are connected to a maintenance computer 22 via some permanent or temporary communication link (such as a bus, a wireless communication system or hand held devices which are connected to the equipment 20 to take readings and are then removed). The maintenance computer 22 may store and execute known monitoring and diagnostic applications 23 provided by, for example, CSI (an Emerson Process Management Company) or other any other known applications used to diagnose, monitor and optimize the operating state of the rotating equipment 20. Maintenance personnel usually use the applications 23 to maintain and oversee the performance of rotating equipment 20 in the plant 10, to determine problems with the rotating equipment 20 and to determine when and if the rotating equipment 20 must be repaired or replaced. In some cases, outside consultants or service organizations may temporarily acquire or measure data pertaining to the equipment 20 and use this data to perform analyses for the equipment 20 to detect problems, poor performance or other issues effecting the equipment 20. In these cases, the computers running the analyses may not be connected to the rest of the system 10 via any communication line or may be connected only temporarily.

Similarly, a power generation and distribution system 24 having power generating and distribution equipment 25 associated with the plant 10 is connected via, for example, a bus, to another computer 26 which runs and oversees the operation of the power generating and distribution equipment 25 within the plant 10. The computer 26 may execute known power control and diagnostics applications 27 such a as those provided by, for example, Liebert and ASCO or other companies to control and maintain the power generation and distribution equipment 25. Again, in many cases, outside consultants or service organizations may use service applications that temporarily acquire or measure data pertaining to the equipment 25 and use this data to perform analyses for the equipment 25 to detect problems, poor performance or other issues effecting the equipment 25. In these cases, the computers (such as the computer 26) running the analyses may not be connected to the rest of the system 10 via any communication line or may be connected only temporarily.

As illustrated in FIG. 1, a computer system 30 implements at least a portion of an abnormal situation prevention system 35, and in particular, the computer system 30 stores and implements a configuration application 38 and, optionally, an abnormal operation detection system 42, which will be described in more detail below. Additionally, the computer system 30 may implement an alert/alarm application 43.

Generally speaking, the abnormal situation prevention system 35 may communicate with abnormal operation detection systems (not shown in FIG. 1) optionally located in the field devices 15, 16, the controllers 12B, 14B, the rotating equipment 20 or its supporting computer 22, the power generation equipment 25 or its supporting computer 26 and any other desired devices and equipment within the process plant 10, and/or the abnormal operation detection system 42 in the computer system 30, to configure each of these abnormal operation detection systems and to receive information regarding the operation of the devices or subsystems that they are monitoring. The abnormal situation prevention system 35 may be communicatively connected via a hardwired bus 45 to each of the computers or devices within the plant 10 or, alternatively, may be connected via any other desired communication connection including, for example, wireless connections, dedicated connections which use OPC, intermittent connections, such as ones which rely on handheld devices to collect data, etc. Likewise, the abnormal situation prevention system 35 may obtain data pertaining to the field devices and equipment within the process plant 10 via a LAN or a public connection, such as the Internet, a telephone connection, etc. (illustrated in FIG. 1 as an Internet connection 46) with such data being collected by, for example, a third party service provider. Further, the abnormal situation prevention system 35 may be communicatively coupled to computers/devices in the plant 10 via a variety of techniques and/or protocols including, for example, Ethernet, Modbus, HTML, XML, proprietary techniques/protocols, etc. Thus, although particular examples using OPC to communicatively couple the abnormal situation prevention system 35 to computers/devices in the plant 10 are described herein, one of ordinary skill in the art will recognize that a variety of other methods of coupling the abnormal situation prevention system 35 to computers/devices in the plant 10 can be used as well.

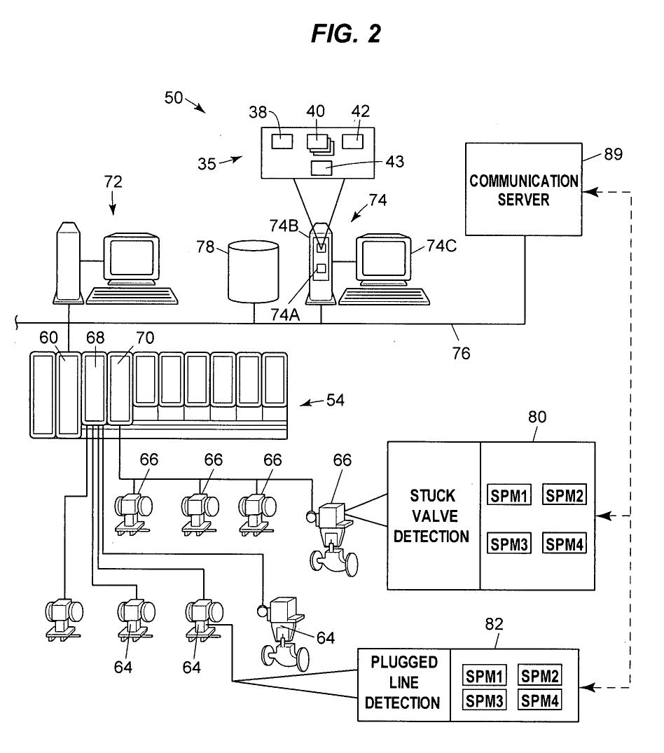

FIG. 2 illustrates a portion 50 of the example process plant 10 of FIG. 1 for the purpose of describing one manner in which statistical data collection may be performed by the abnormal situation prevention system 35. While FIG. 2 illustrates communications between the abnormal situation prevention system applications 38, 40 and 42 and the database 43 and one or more data collection blocks within HART and Fieldbus field devices, it will be understood that similar communications can occur between the abnormal situation prevention system applications 38, 40 and 42 and other devices and equipment within the process plant 10, including any of the devices and equipment illustrated in FIG. 1.

The portion 50 of the process plant 10 illustrated in FIG. 2 includes a distributed process control system 54 having one or more process controllers 60 connected to one or more field devices 64 and 66 via input/output (I/O) cards or devices 68 and 70, which may be any desired types of I/O devices conforming to any desired communication or controller protocol. The field devices 64 are illustrated as HART field devices and the field devices 66 are illustrated as Fieldbus field devices, although these field devices could use any other desired communication protocols. Additionally, the field devices 64 and 66 may be any types of devices such as, for example, sensors, valves, transmitters, positioners, etc., and may conform to any desired open, proprietary or other communication or programming protocol, it being understood that the I/O devices 68 and 70 must be compatible with the desired protocol used by the field devices 64 and 66.

In any event, one or more user interfaces or computers 72 and 74 (which may be any types of personal computers, workstations, etc.) accessible by plant personnel such as configuration engineers, process control operators, maintenance personnel, plant managers, supervisors, etc. are coupled to the process controllers 60 via a communication line or bus 76 which may be implemented using any desired hardwired or wireless communication structure, and using any desired or suitable communication protocol such as, for example, an Ethernet protocol. In addition, a database 78 may be connected to the communication bus 76 to operate as a data historian that collects and stores configuration information as well as on-line process variable data, parameter data, status data, and other data associated with the process controllers 60 and field devices 64 and 66 within the process plant 10. Thus, the database 78 may operate as a configuration database to store the current configuration, including process configuration modules, as well as control configuration information for the process control system 54 as downloaded to and stored within the process controllers 60 and the field devices 64 and 66. Likewise, the database 78 may store historical abnormal situation prevention data, including statistical data collected by the field devices 64 and 66 within the process plant 10, statistical data determined from process variables collected by the field devices 64 and 66, and other types of data.

While the process controllers 60, I/O devices 68 and 70, and field devices 64 and 66 are typically located down within and distributed throughout the sometimes harsh plant environment, the workstations 72 and 74, and the database 78 are usually located in control rooms, maintenance rooms or other less harsh environments easily accessible by operators, maintenance personnel, etc.

Generally speaking, the process controllers 60 store and execute one or more controller applications that implement control strategies using a number of different, independently executed, control modules or blocks. The control modules may each be made up of what are commonly referred to as function blocks, wherein each function block is a part or a subroutine of an overall control routine and operates in conjunction with other function blocks (via communications called links) to implement process control loops within the process plant 10. As is well known, function blocks, which may be objects in an object-oriented programming protocol, typically perform one of an input function, such as that associated with a transmitter, a sensor or other process parameter measurement device, a control function, such as that associated with a control routine that performs PID, fuzzy logic, etc. control, or an output function, which controls the operation of some device, such as a valve, to perform some physical function within the process plant 10. Of course, hybrid and other types of complex function blocks exist, such as model predictive controllers (MPCs), optimizers, etc. It is to be understood that while the Fieldbus protocol and the DeltaV™ system protocol use control modules and function blocks designed and implemented in an object-oriented programming protocol, the control modules may be designed using any desired control programming scheme including, for example, sequential function blocks, ladder logic, etc., and are not limited to being designed using function blocks or any other particular programming technique.

As illustrated in FIG. 2, the maintenance workstation 74 includes a processor 74A, a memory 74B and a display device 74C. The memory 74B stores the abnormal situation prevention applications 38, 40 and 42 discussed with respect to FIG. 1 in a manner that these applications can be implemented on the processor 74A to provide information to a user via the display 74C (or any other display device, such as a printer).

As illustrated in FIG. 2, the maintenance workstation 74 includes a processor 74A, a memory 74B and a display device 74C. The memory 74B stores the abnormal situation prevention application 35 and the alert/alarm application 43 discussed with respect to FIG. 1 in a manner that these applications can be implemented on the processor 74A to provide information to a user via the display 74C (or any other display device, such as a printer).

Each of one or more of the field devices 64 and 66 may include a memory (not shown) for storing routines such as routines for implementing statistical data collection pertaining to one or more process variables sensed by sensing device and/or routines for abnormal operation detection, which will be described below. Each of one or more of the field devices 64 and 66 may also include a processor (not shown) that executes routines such as routines for implementing statistical data collection and/or routines for abnormal operation detection. Statistical data collection and/or abnormal operation detection need not be implemented by software. Rather, one of ordinary skill in the art will recognize that such systems may be implemented by any combination of software, firmware, and/or hardware within one or more field devices and/or other devices.

As shown in FIG. 2, some (and potentially all) of the field devices 64 and 66 include abnormal operation detection blocks 80 and 82, which will be described in more detail below. While the blocks 80 and 82 of FIG. 2 are illustrated as being located in one of the devices 64 and in one of the devices 66, these or similar blocks could be located in any number of the field devices 64 and 66, could be located in other devices, such as the controller 60, the I/O devices 68, 70 or any of the devices illustrated in FIG. 1. Additionally, the blocks 80 and 82 could be in any subset of the devices 64 and 66.

Generally speaking, the blocks 80 and 82 or sub-elements of these blocks, collect data, such a process variable data, within the device in which they are located and perform statistical processing or analysis on the data for any number of reasons. For example, the block 80, which is illustrated as being associated with a valve, may have a stuck valve detection routine which analyzes the valve process variable data to determine if the valve is in a stuck condition. In addition, the block 80 includes a set of four statistical process monitoring (SPM) blocks or units SPM1-SPM4 which may collect process variable or other data within the valve and perform one or more statistical calculations on the collected data to determine, for example, a mean, a median, a standard deviation, a root-mean-square (RMS), a rate of change, a minimum, a maximum, etc. of the collected data. The specific statistical data generated, nor the method in which it is generated is not critical. Thus, different types of statistical data can be generated in addition to, or instead of, the specific types described above. Additionally, a variety of techniques, including known techniques, can be used to generate such data. The term statistical process monitoring (SPM) block is used herein to describe functionality that performs statistical process monitoring on at least one process variable or other process parameter, and may be performed by any desired software, firmware or hardware within the device or even outside of a device for which data is collected. It will be understood that, because the SPMs are generally located in the devices where the device data is collected, the SPMs can acquire quantitatively more and qualitatively more accurate process variable data. As a result, the SPM blocks are generally capable of determining better statistical calculations with respect to the collected process variable data than a block located outside of the device in which the process variable data is collected.

It is to be understood that although the blocks 80 and 82 are shown to include SPM blocks in FIG. 2, the SPM blocks may instead be stand-alone blocks separate from the blocks 80 and 82, and may be located in the same device as the corresponding block 80 or 82 or may be in a different device. The SPM blocks discussed herein may comprise known Foundation Fieldbus SPM blocks, or SPM blocks that have different or additional capabilities as compared with known Foundation Fieldbus SPM blocks. The term statistical process monitoring (SPM) block is used herein to refer to any type of block or element that collects data, such as process variable data, and performs some statistical processing on this data to determine a statistical measure, such as a mean, a standard deviation, etc. As a result, this term is intended to cover software, firmware, hardware and/or other elements that perform this function, whether these elements are in the form of function blocks, or other types of blocks, programs, routines or elements and whether or not these elements conform to the Foundation Fieldbus protocol, or some other protocol, such as Profibus, HART, CAN, etc. protocol. If desired, the underlying operation of blocks 50 may be performed or implemented at least partially as described in U.S. Pat. No. 6,017,143, which is hereby incorporated by reference herein.

It is to be understood that although the blocks 80 and 82 are shown to include SPM blocks in FIG. 2, SPM blocks are not required of the blocks 80 and 82. For example, abnormal operation detection routines of the blocks 80 and 82 could operate using process variable data not processed by an SPM block. As another example, the blocks 80 and 82 could each receive and operate on data provided by one or more SPM block located in other devices. As yet another example, the process variable data could be processed in a manner that is not provided by many typical SPM blocks. As just one example, the process variable data could be filtered by a finite impulse response (FIR) or infinite impulse response (IIR) filter such as a bandpass filter or some other type of filter. As another example, the process variable data could be trimmed so that it remained in a particular range. Of course, known SPM blocks could be modified to provide such different or additional processing capabilities.

The block 82 of FIG. 2, which is illustrated as being associated with a transmitter, may have a plugged line detection unit that analyzes the process variable data collected by the transmitter to determine if a line within the plant is plugged. In addition, the block 82 may includes one or more SPM blocks or units such as blocks SPM1-SPM4 which may collect process variable or other data within the transmitter and perform one or more statistical calculations on the collected data to determine, for example, a mean, a median, a standard deviation, etc. of the collected data. While the blocks 80 and 82 are illustrated as including four SPM blocks each, the blocks 80 and 82 could have any other number of SPM blocks therein for collecting and determining statistical data.

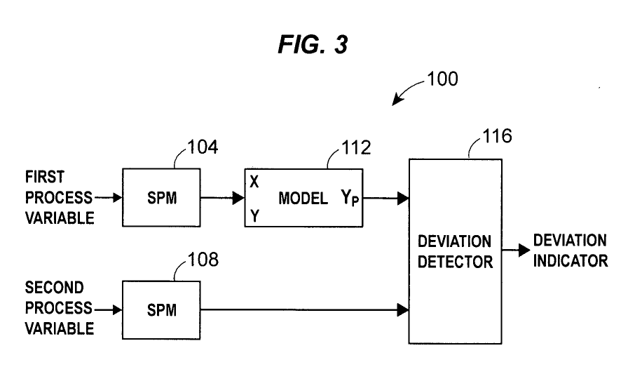

FIG. 3 is a block diagram of an example of an abnormal situation prevention system 100 that could be utilized in the abnormal situation prevention blocks 80 and 82 of FIG. 2. The abnormal situation prevention system 100 includes a first SPM block 104 and a second SPM block 108 coupled to a model 112. The first SPM block 104 receives a first process variable and generates first statistical data from the first process variable. The first statistical data could be any of various kinds of statistical data such as mean data, median data, standard deviation data, rate of change data, range data, etc., calculated from the first process variable. Such data could be calculated based on a sliding window of first process variable data or based on non-overlapping windows of first process variable data. As one example, the first SPM block 104 may generate mean data using a most recent first process variable sample and 49 previous samples of the first process variable. In this example, a mean variable value may be generated for each new first process variable sample received by the first SPM block 104. As another example, the first SPM block 104 may generate mean data using non-overlapping time periods. In this example, a window of five minutes (or some other suitable time period) could be used, and a mean variable value would thus be generated every five minutes. In a similar manner, the second SPM block 108 receives a second process variable and generates second statistical data from the second process variable in a manner similar to the SPM block 104.

The model 112 includes inputs for receiving values of an independent variable x and a dependent variable y. The model 112 may be trained using a plurality of (x, y) data sets to model the dependent variable y as a function of the independent variable x. The model 112 may include a regression model. The regression model utilizes a function to model the dependent variable y as a function of the independent variable x over some range of x. The regression model may be a linear regression model, or some other regression model. A linear regression model may comprise a first order function of x (e.g., y=a₀+a₁x), a second order function of x (e.g., y=a₀+a₁x+a₂x²), or a polynomial of some other order p (e.g., y=a₀+a₁x+a₂x²+ . . . +aₚx^{p}). Alternatively, an extensible regression model may be employed to model the dependent/(monitored) variable x as a function of the independent (load) variable y, or a hybrid autoscaling technique may be employed to create the model. A method of creating an extensible regression model is disclosed in U.S. patent application Ser. No. 11/492,497 filed Jul. 25, 2006 and titled Method and System for Detecting Abnormal Operation in a Process Plant. A hybrid autoscaling method of creating a regression model is disclosed in U.S. patent application Ser. No. 11/619,830 filed on Jan. 4, 2007 and titled Method and System for Modeling Behavior in a Process Plant. The entire disclosures of both of the above-identified U.S. patent applications are incorporated herein by reference.

After it has been trained, the model 112 may be used to generate a predicted value (y_{P}) of a dependent variable y based on a given input value of the independent variable x. The predicted value of the dependent variable output y_{P} is provided to a deviation detector 116. The deviation detector 116 receives the predicted value of the dependent variable y_{P} as well as the actual value of the dependent variable y corresponding to the input value of the independent variable x. The deviation detector 116 compares the actual value of the dependent variable y to the predicted value of the dependent value y_{P} to determine whether the value of the dependent variable y varies significantly from the predicted value of the dependent variable y_{P}. If the value of the dependent variable y is significantly different from the predicted value of the dependent variable y_{P} an abnormal situation may have occurred, is occurring, or may occur in the near future. In these circumstances the deviation detector 116 may generate a deviation indicator indicating the presence of an abnormal situation. In some implementations the indicator may comprise an alert or alarm.

The abnormal situation prevention system 100 could be implemented wholly or partially in a field device. As just one example, the SPM blocks 104 and 108 could be implemented in a field device 66 and the model 112 and/or the deviation detector 116 could be implemented in the controller 60 or some other device. In one particular implementation, the abnormal situation prevention system 100 could be implemented as a function block, such as a function block to be used in a system that implements the fieldbus protocol. Such a function block may or may not include the SPM blocks 104 and 108. In another implementation, at least some of the blocks 104, 108, 112, and 116 may be implemented as a function block.

As described above, many abnormal situation prevention algorithms rely on a linear regression to model a monitored variable as a function of a corresponding load variable. The regression model is calculated from a set of training data containing a number of corresponding samples of the load and monitored variables measured from the controlled process. The regression model comprises a function or curve that best fits the data in the training set. The regression model may comprise a polynomial function of a specified order p. In general, the higher the order of polynomial function, the better the regression model will fit the training data. With higher order polynomial regressions, however, rounding off errors may accumulate in the calculation of the polynomial coefficients to a point where the resulting regression curve bears little or no resemblance to the actual data in the training set.

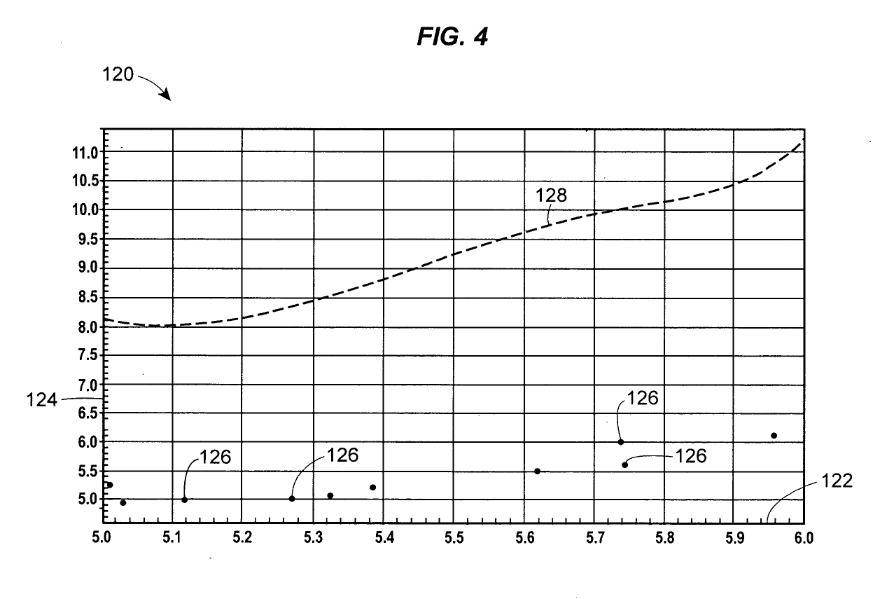

For example, FIG. 4 shows a sixth order polynomial regression curve 128 for a sample training data set. An x-y coordinate system 120 includes a horizontal axis 122 and a vertical axis 124. The horizontal axis 122 represents values of the independent variable x, and the vertical axis 124 represents values of the dependent variable y. The training data comprise a plurality of (x, y) points 126 shown plotted on the x-y coordinate system 120. As can be seen, the data points 126 exhibit a general upward trend in which the value of the dependent variable y generally increases with higher values of the independent variable x. Overall, however, the values of the dependent variable y, remain relatively small. The largest value of the dependent variable in the training set, yₘₐₓ, is approximately 6.2. The sixth order polynomial regression curve 128, on the other hand, has values far exceeding even the largest value of the independent variable in the training set. The y values of the polynomial regression model range from approximately 8.0 to above 11.0. Clearly, the sixth order polynomial regression curve 128 does not accurately represent the data in the training set and is invalid.

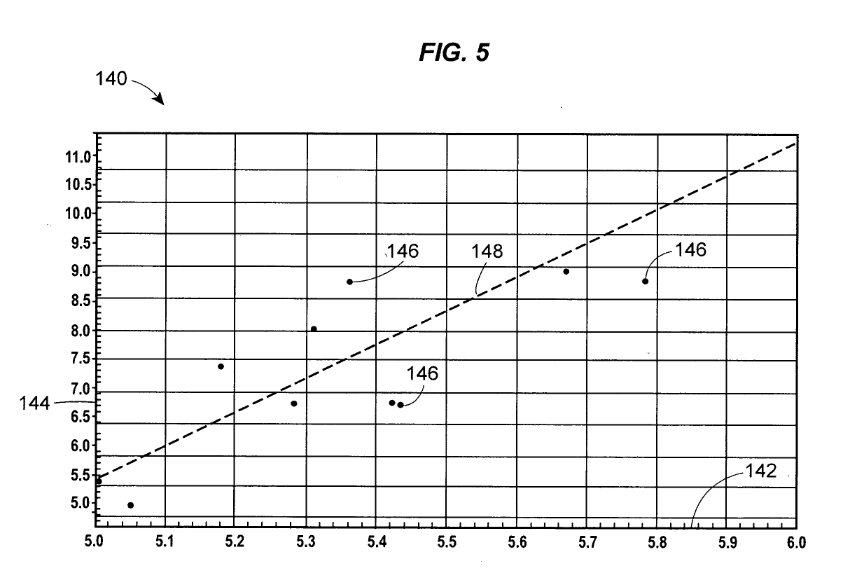

On the other hand, FIG. 5 shows a first order (linear) polynomial curve 148 for another sample training set. Again, an x-y coordinate system 140 includes a horizontal axis 142 and a vertical axis 144. The horizontal axis 142 represents the independent variable x and the vertical axis represents the dependent variable y. The training data comprise a plurality of (x,y) points 146 plotted on the x-y coordinate system 140. Again, the general trend in the data is upward. The value of the dependent variable y tends to increase with increasing values of the independent variable x. The positive slope of the linear regression curve 148 reflects this general trend. The first order polynomial regression curve 148 follows the general pattern of the data points 146 and follows a middling path between the points, with some points 146 lying above the first order polynomial regression curve 148 and others below. Just as the sixth order polynomial regression curve 128 of FIG. 4 was clearly invalid for the data points 126 from which the polynomial regression curve 128 was calculated, the first order polynomial regression curve 148 appears appropriate for the data points 146 from which the first order polynomial regression curve 148 was calculated.

Although it is visually apparent that the sixth order polynomial regression curve 128 of FIG. 4 is invalid and that the first order polynomial regression curve 148 of FIG. 5 is valid, an objective test or algorithm is necessary so that a processor within an abnormal situation prevention system may evaluate the regression models 128, 148 to determine whether they are valid, or whether measures must be taken to compensate for invalid models. According to an embodiment of an abnormal situation prevention system, a method for determining whether a polynomial regression model is valid is to calculate the average value of the polynomial regression model over the range of independent variable values included within the training set and determine whether the average value of the polynomial regression model falls within the range of values between the lowest and highest values of the dependent variable found in the training set.

The average value of a real continuous function f(x) over an interval [a, b] is the integral of the function over the interval divided by the range of the interval:

$$\overline{f} = \frac{1}{b - a} {\int }_{a}^{b} f ( x ) d x . \qquad ( 1 )$$

If the function is a polynomial of the form ƒ(x)=a₀+a_{b}x=a₂x²+ . . . aₚx^{p}, and the range is the interval [xₘᵢₙ, xₘₐₓ], then the average value of the function becomes:

$$\overline{f} = \frac{1}{{x}_{max} - {x}_{min}} {\int }_{{x}_{max}}^{{x}_{max}} {a}_{0} + {a}_{1} x + {a}_{2} {x}^{2} + , … {a}_{p} {x}^{p} d x \qquad ( 2 )$$

### Integrating we get:

$$\overline{f} = {\frac{1}{{x}_{max} - {x}_{min}} [ {a}_{0} x + \frac{{a}_{1} {x}^{2}}{2} + \frac{{a}_{2} {x}^{3}}{3} + , … \frac{{a}_{p} {x}^{p + 1}}{p + 1} ]}_{{x}_{min}}^{{x}_{max}} \qquad ( 3 )$$

which may be rewritten as:

$$\overline{f} = \frac{1}{{x}_{max} - {x}_{min}} [ {a}_{0} \frac{{a}_{1}}{2} + \frac{{a}_{2}}{3} + , … \frac{{a}_{p}}{p + 1} ] \cdot [ \begin{matrix}{x}_{max} - {x}_{min} \\ {x}_{max}^{2} - {x}_{min}^{2} \\ {x}_{max}^{3} - {x}_{min}^{3} \\ … \\ {x}_{max}^{P + 1} - {x}_{min}^{p + 1}\end{matrix} ] \qquad ( 4 )$$

The quantity (a^{p}-b^{p}) may be factored as follows:

$$\begin{matrix}{a}^{p} - {b}^{p} = ( a - b ) ( \begin{matrix}{a}^{p - 1} + {a}^{p - 2} b + {a}^{p - 3} {b}^{2} + … + \\ {a}^{2} {b}^{p - 3} + {ab}^{p - 2} + {b}^{p - 1}\end{matrix} ) \\ = ( a - b ) {\sum }_{i = 0}^{p - 1} {a}^{i} {b}^{p - i - 1}\end{matrix}$$

Using the above factorization with a=xₘₐₓ and b=xₘᵢₙ the formula for calculating the average value of the polynomial function from xₘᵢₙ to xₘₐₓ becomes:

$$\overline{f} = [ a \frac{{a}_{1}}{2} \frac{{a}_{2}}{3} … \frac{{a}_{p}}{p + 1} ] \cdot [ \begin{matrix}1 \\ {x}_{max} + {x}_{min} \\ {x}_{max}^{2} + {x}_{max} {x}_{min} + {x}_{min}^{2} \\ … \\ {\sum }_{i = 0}^{p} {x}_{min}^{i} {x}_{max}^{p - i}\end{matrix} ] \qquad ( 5 )$$

(The last substitution reduces the number of multiplications necessary to calculate the average of the polynomial function and may diminished the possibility of rounding off errors on some processing platforms.) In the context of an abnormal situation prevention system equation (5) can be used to calculate the average value of a polynomial regression model derived from a set of training data including a plurality of (x, y) data points.

Once the average value ƒ̅ of the polynomial regression model has been calculated it remains only to determine whether the values of ƒ̅ falls between the minimum and maximum values of the dependent variable y in the training set. In other words, if:

yₘᵢₙ≦f≦yₘₐₓ (6)

the model is valid.

The above method for determining whether a regression model is valid may be employed in an iterative manner until a valid regression model is obtained. The process may begin by calculating a polynomial regression model of the highest order pₘₐₓ allowed by the abnormal situation prevention system. The above method is employed to determine whether the polynomial regression model is valid. If the model is valid it may be used to detect abnormal situations in the monitoring phase. If the model is invalid, the polynomial order may be reduced by one and a new polynomial regression model may be calculated from the training data. The new polynomial regression model may be tested as described above to determine whether the new polynomial regression is valid, and so forth. The process continues until valid polynomial regression model is achieved.

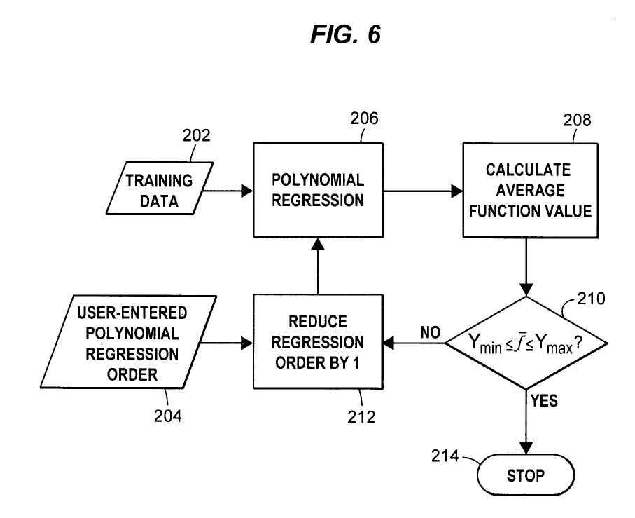

The above process for finding a valid polynomial regression model is illustrated in the flow chart 200 of FIG. 6. A set of training data is received at 202. The maximum polynomial order pₘₐₓ is set at 204. pₘₐₓ may be a user defined parameter, or it may be determined automatically based on the data included in the training data set. A polynomial regression model of order p is calculated at 206. The initial order of the polynomial is p=pₘₐₓ. Once the polynomial regression model has been calculated, the average value of the polynomial function ƒ̅ is calculated at 208. ƒ̅ is compared to yₘᵢₙ and yₘₐₓ, the minimum and maximum values of the dependent variable found in the training data. If xₘᵢₙ≦ ƒ̅≦xₘₐₓ the model is valid and the process of finding a valid model ends at 214. Otherwise, if xₘᵢₙ≦ ƒ̅≦xₘₐₓ does not hold, the polynomial order p is reduced by 1 at 212, and a new regression model is calculated at 206. And so the process continues until a valid polynomial regression model is obtained.

The process described above may be implemented on a number of different platforms. For example, the process may be implemented in a field device. In another embodiment, the process may be implemented in a Foundation™ fieldbus function or transducer block. Alternatively, the process could be implemented in a field device interface module such as the Rosemount 3420 provided by Emerson Process Management, in a control system such as DeltaV™ or Ovation™ both also provided by Emerson Process Management, or in a stand-alone software application. In all cases, the process may be implemented in order to recognize invalid regression models and recalculate the regression models to achieve a valid model that may be applied to abnormal situation prevention in a process plant.

Thus, while the present disclosure has been described with reference to specific examples, which are intended to be illustrative only and not to be limiting, it will be apparent to those of ordinary skill in the art that changes, additions or deletions may be made to the disclosed embodiments without departing from the spirit and scope of the disclosure.

1. An abnormal prevention system comprising:
at least one field device adapted to measure process control data associated with first and second process control variables; and
one or more processors adapted to generate a model for modeling the second process control variable as a function of the first process control variable based on a plurality of corresponding first and second variable sample values received in a set of training data, the one or more processors further adapted to execute an algorithm for determining whether the model is valid.

2. The abnormal situation prevention system of claim 1, wherein the algorithm for determining whether the model is valid comprises determining the minimum and maximum values of the second process control variable included in the set of training data, calculating an average value of the model, and determining whether the average value of the model falls between the minimum and maximum values of the second process control variable included in the set of training data.

3. The abnormal situation prevention system of claim 2 wherein the model is a polynomial regression model having a polynomial order p and polynomial coefficients aₒ, a₁, . . . aₚ.

4. The abnormal situation prevention system of claim 3 wherein the one or more processors are adapted to calculate the average value of the polynomial regression according to a formula:
$$\overline{f} = [ {a }_{0} + \frac{{a}_{1}}{2} + \frac{{a}_{2}}{3} + , … , + \frac{{a}_{p}}{p + 1} ] \cdot [ \begin{matrix}1 \\ {x}_{max} + {x}_{min} \\ {x}_{max}^{2} + {x}_{max} {x}_{min} + {x}_{min}^{2} \\ … \\ {\sum }_{i = 0}^{p} {x}_{min}^{i} {x}_{max}^{p - 1}\end{matrix} ]$$

5. The abnormal situation prevention system of claim 1, wherein the model comprises a first polynomial regression having an order p and wherein the one or more processors is adapted to calculate a second polynomial regression model having a polynomial order p−1 when the one or more processors determines that the first polynomial regression model is invalid.

6. The abnormal situation prevention system of claim 1 wherein the model comprises an extensible regression model.

7. The abnormal situation prevention system of claim 1 wherein a hybrid autoscaling method is employed to generate a polynomial regression model.

8. The abnormal situation prevention system of claim 1 wherein at least one of the one or more processors is implemented in a process control field device.

9. The abnormal situation prevention system of claim 1, wherein the first process control variable comprises an independent (load) process control variable and the second process control variable comprises a dependent (monitored) process control variable.

10. A method of creating a polynomial regression model for modeling process control data, the method comprising:
receiving a set of training data including a plurality of first process control variable values and a plurality of corresponding second process control variable values;
calculating a polynomial regression model based on the first and second process control variable values in the received set of training data, the polynomial regression model having a polynomial order;
determining whether the polynomial regression model is valid;
reducing the order of the polynomial by 1 if the polynomial regression model is invalid; and
repeating the steps of calculating a polynomial regression model, determining whether the polynomial regression model is valid, and reducing the polynomial order if the polynomial regression model is invalid until a valid polynomial regression model is achieved.

11. The method of claim 10 wherein determining whether the polynomial regression model is invalid comprises identifying minimum and maximum values of the second process control variables included in the set of training data, calculating an average value of the polynomial regression model, and determining whether the average value of the polynomial regression model is within a range defined by the minimum and maximum values of the second process control variable included in the set of training data.

12. The method of claim 11 wherein the average value of the polynomial regression model is calculated according to a formula:
$$\overline{f} = [ {a }_{0} + \frac{{a}_{1}}{2} + \frac{{a}_{2}}{3} + , … , + \frac{{a}_{p}}{p + 1} ] \cdot [ \begin{matrix}1 \\ {x}_{max} + {x}_{min} \\ {x}_{max}^{2} + {x}_{max} {x}_{min} + {x}_{min}^{2} \\ … \\ {\sum }_{i = 0}^{p} {x}_{min}^{i} {x}_{max}^{p - 1}\end{matrix} ]$$

13. The method of claim 10 wherein at least one of the steps of calculating a polynomial regression model, determining whether the polynomial regression model is valid, or reducing the order of the polynomial regression model by 1 if the polynomial regression model is invalid, is carried out in one of: a process control field device; a Foundation™ fieldbus function block; a Foundation™ fieldbus transducer block; a field device interface module; or a stand-alone software application.

14. The method of claim 10 wherein at least one of the steps of calculating a polynomial regression model, determining whether the polynomial regression model is valid, or reducing the order of the polynomial regression by 1 if the polynomial regression model is invalid, is carried out in a process control system.

15. A method for determining whether a data model calculated based on a set of training data that includes a plurality of corresponding values of an independent variable and a dependent variable is valid, the method comprising:
identifying minimum and maximum values of the dependent variable included in the set of training data;
calculating an average value of the data model; and
determining whether the average value of the data model is between the minimum and maximum values of the dependent variable included in the set of training data.

16. The method of claim 15 wherein data model comprises a polynomial regression having a polynomial order.

17. The method of claim 16 further comprising identifying the minimum and maximum values of the independent variable included in the set of training data, and wherein the average value of the data model is calculated according to a formula:
$$\overline{f} = [ {a }_{0} + \frac{{a}_{1}}{2} + \frac{{a}_{2}}{3} + , … , + \frac{{a}_{p}}{p + 1} ] \cdot [ \begin{matrix}1 \\ {x}_{max} + {x}_{min} \\ {x}_{max}^{2} + {x}_{max} {x}_{min} + {x}_{min}^{2} \\ … \\ {\sum }_{i = 0}^{p} {x}_{min}^{i} {x}_{max}^{p - 1}\end{matrix} ]$$
where
ƒ̅ is the average value of the polynomial regression model;
a₀, a₁, . . . , aₚ are coefficients of the polynomial regression model;
p is the order of the polynomial regression model;
xₘᵢₙ is the minimum value of the independent variable included in the set of training data; and
xₘₐₓ is the maximum value of the independent variable included in the set of training data.

18. The method of claim 15 wherein the data model is calculated according to one of: an extensible regression algorithm; or a hybrid autoscaling method.

19. A system for detecting an abnormal situation in a controlled process, the system comprising:
a first input for receiving first process variable data;
a second input for receiving second process variable data; and
a processor adapted to perform a regression for modeling the second process variable data as a function of the first process variable data, the processor further adapted to execute an algorithm for determining whether the regression model is valid.

20. The abnormal situation prevention system of claim 19, wherein the algorithm for determining whether the model is valid comprises determining the minimum and maximum values of the second process control variable, calculating an average value of the model, and determining whether the average value of the model falls between the minimum and maximum values of the second process control variable.

21. The abnormal situation prevention system of claim 20 wherein the model is a polynomial regression model having a polynomial order p and polynomial coefficients a₀, a₁, . . . , aₚ, and wherein the average value of the polynomial regression is calculated according to the formula:
$$\overline{f} = [ {a }_{0} + \frac{{a}_{1}}{2} + \frac{{a}_{2}}{3} + , … , + \frac{{a}_{p}}{p + 1} ] \cdot [ \begin{matrix}1 \\ {x}_{max} + {x}_{min} \\ {x}_{max}^{2} + {x}_{max} {x}_{min} + {x}_{min}^{2} \\ … \\ {\sum }_{i = 0}^{p} {x}_{min}^{i} {x}_{max}^{p - 1}\end{matrix} ] .$$

22. The abnormal situation prevention system of claim 19, wherein the model comprises a first polynomial regression having an order p and wherein the one or more processors is adapted to calculate a second polynomial regression model having a polynomial order p−1 when the one or more processors determines that the first polynomial regression model is invalid.

23. The abnormal situation prevention system of claim 19 wherein the model comprises an extensible regression model.

24. The abnormal situation prevention system of claim 19 wherein a hybrid autoscaling method is employed to generate a polynomial regression model.

25. The abnormal situation prevention system of claim 19 wherein at least one of the one or more processors is implemented in a process control field device; a field device interface module; a hand held field device communicator; or a process controller.
